(19) United States
(12) Patent Application Publication
(10) Pub. No.: US 2005/0177439 A1
(43) Pub. Date: Aug. 11, 2005

(54) Method of obtaining music scores

(76) Inventor: Bjorn Thulin, Stockholm (SE)

Correspondence Address: FASTH LAW OFFICES (ROLF FASTH), 26 PINECREST PLAZA, SUITE 2, SOUTHERN PINES, NC, 28387-4301, US

(21) Appl. No.: 10/509,648

(22) PCT Filed: Mar. 24, 2003
(86) PCT No.: PCT/US03/09142

Related U.S. Application Data
(60) Provisional application No. 60/368,682, filed on Mar. 29, 2002.

(51) Int. Cl. G06F 17/60

(52) U.S. Cl. 705/26

(57) ABSTRACT

The method is for using the Internet to facilitate a transaction between a customer and at least one supplier of music scores to discourage illegal copying of music scores. The customer contacts a website (16) of the service unit (18) and sends a request signal (19) to the website (16) to obtain a music-score (20). The service unit (18) digitally searches for the music score (20) in a database (22). When no copy is available, request signals (24a-c) are sent to the suppliers (26, 28, 30). If a copy is available, the supplier sends an affirmation signal and the digital copy (35) of the music score to the service unit (18). The service unit (18) can also make transpositions according to the requirements of the customer (12). The service unit (18) charges the customer (12) that pays and then forwards the digital copy. The service unit (18) then compensates the supplier (28) minus a service charge.

### TECHNICAL FIELD

The present invention relates to a method for digitally obtaining music scores.

### BACKGROUND INFORMATION

Musicians are finding it increasingly difficult to obtain music scores and other music documents. Many of the suppliers have gone out of business partly due to the excessive illegal copying that exists. It is also sometimes difficult to obtain the requested music scores because they are not readily available. The illegal copying drives up the prices for legally obtained music scores that in turn encourage more illegal copying. There is a need for a quick, reliable and inexpensive way of obtaining music scores to stop the vicious circle of illegal copying. The present invention provides a solution to the above outlined problems.

### SUMMARY OF INVENTION

The method of the present invention provides a solution to the above-outlined problems. More particularly, the method is for using the Internet to facilitate a transaction between a customer and at least one supplier of music scores to discourage illegal copying of music scores. The customer contacts a website of the service unit and sends a request signal to the website to obtain a music score. The service unit digitally searches for the music score in a database. When no copy is available request signals are sent to the suppliers. If a copy is available, the supplier sends an affirmation signal and the digital copy of the music score to the service unit. The service unit charges the customer that pays and then forwards the digital copy. The service unit then compensates the supplier minus a service charge and sends a copyright royalty to the copyright owner.

### BRIEF DESCRIPTION OF THE DRAWINGS

FIG. 1 is a schematic view of a digital system for music scores according to the present invention.

### DETAILED DESCRIPTION

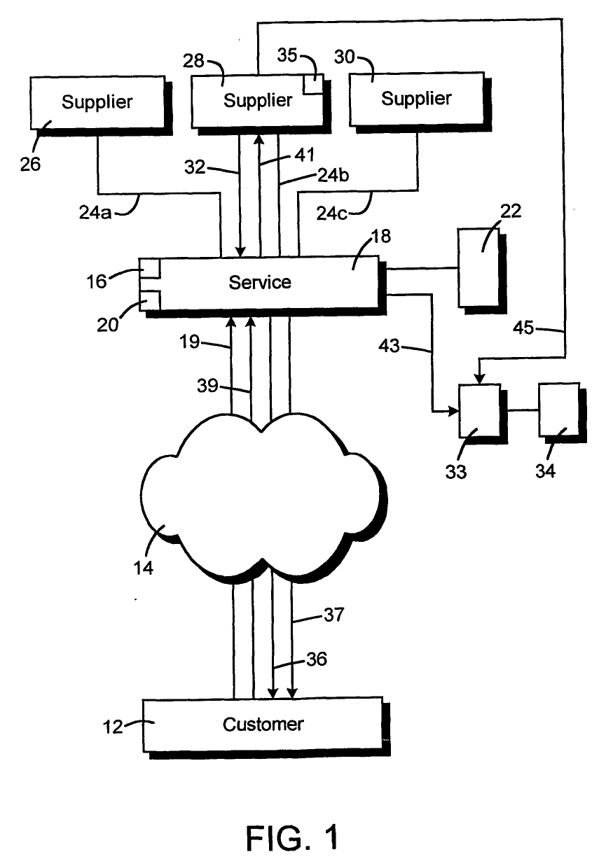

With reference to FIG. 1, the present invention is a unique music score system 10 that allows customers to digitally obtain the desired music scores. More particularly, the system 10 has a customer 12 that is connected via a network 14, such as the Internet, to a web-site 16 of a service unit 18. Of course, the system 10 may have many customers. The web-site 16 may include a suitable search engine so that the customer 12 may find exactly the music score the customer is looking for. The unit 18 receives a request signal 19 from the customer 12 to obtain a particular music score 20. The unit 18 may digitally search a local database 22 for a digital copy of the requested music score 20. If no copy is available in the database 22 then request signals 24a-c are sent to suppliers 26, 28, 30 of music scores. The music scores suppliers may be both national and international suppliers.

An important feature of the system 10 is that the unit 18 may ask all suppliers for the music scores requested to increase the availability for the customer. The customer 12 most often would like to have access to all the suppliers of music scores if possible. The system 10 should have access to all the music scores the suppliers have available, just like any musik book store would have, not just certain music scores. One of the suppliers, such as the supplier 28, may send back an affirmation signal 32 with the requested music score as a digital attachment. If the requested music score is only available in analog form, the unit 18 may convert the music score into a digital form so that the customer 12 may download the music score from the web-site 16 in a delivery signal 36 without having to go to a music store to obtain the physical copy. The signal 36 may include the music score in a pdf-form or according to any other suitable protocol. The web site 16 may provide guidance to the customer 12 about how to download the requested music scores. It is also possible for the supplier 28 to carry out the conversion from analog to digital form.

The system 10 may require that the customer 12 pre-registers and pre-pays the service unit 18 for the requested music scores so the supplier 28 knows that the supplier will be compensated for the conversion and the music scores itself since the service unit 18 has established good credibility with all the suppliers. The unit 18 pays the supplier the amount received minus a service charge. The unit 18 may also provide a record of the transactions for the royalty payments that may be requested from a control function 33, as described below and indicated in the report signal 43. Royalties may be of great diversity and the unit may be designed to merely indicate the amount of scores delivered. It may not be necessary for the service unit 18 to pay the supplier for each transaction separately but the supplier only pays on a yearly or monthly basis to reduce the administrative costs. It may be possible for the unit 18 to require or recommend the customer 12 to establish a client fund at the unit 18 that is large enough to be sufficient for several purchases. The customer 12 may be assigned a unique identification number or code to provide access to the service of the unit 18 and the customer's client fund.

The copyright control function 33, such as STIM, ASCAP or similar organizations, may have access through delivered lists from the unit 18 to make sure copyright owners 34 of the music scores are paid a royalty for every music score that is delivered to the customer 12. The function 33 may only, upon request, be provided with information about the selling amount. Royalty payments to copyright owners are preferably exclusively handled by the suppliers such as from the supplier 28 as indicated in the payment signal 45. The original copyright fee between the suppliers and the copyright owners may also be based on an agreement about the amount of music scores originally printed by the suppliers. The function 33 may obtain lists of copyrighted music scores but not necessarily access to the service provided by the service unit 18. An essential feature of the present invention is that the digital copy must be sufficiently inexpensive not to encourage illegal copying.

The music score obtained by the service 18 may also be stamped as a legal original, thereby making the illegal copying much less interesting, since the customer 12 will never risk performing with an illegal copy. It may even be possible for the customer 12 to order one page of a music score that may be missing from the music piece. By contacting the service unit 18, the customer 12 may simply download the missing pages of a music score for a reasonable price such as $1 per page.

Another important feature of the present invention is that the music scores should be instantly available or be delivered within 24 hours. It may even be possible to provide a reduced price if the requested music score is not delivered within the time period promised. The pre-payment may also be returned to the customer or collected on his account if the music score is not delivered within 24 hours. When the requested music score is then available to the service unit 18, the unit 18 may send an email to the customer 12 to notify the customer that the music score the customer requested earlier is now available.

The pricing of the music scores may be adapted to the consumption volume of the consumers so large consumers may obtain progressive discounts.

The number of individual consumers, as revealed during the client registration, within each institution or large consumer may also be used to control or check that there is no illegal copying within the institution. For example, if an institution that has hundreds of users only buys one copy each time, this may be an indication that illegal copying is taking place within the institution so that the service unit 18 may alert the control function 33. The unit 18 may have software programs that analysis the buying pattern of each customer to identify suspicious behavior thus also beeing an instrument for marketing and positioning.

Because all information is provided digitally, it may also be possible for the service unit 18 to provide transposition services to the customer 12 for a fee. This fee may be the same as the charge for the music score so that the customer 12 must, for example, pay $2. The service unit 18 should cooperate with a third party that leases equipment to improve the reliability and scalability of the unit 18.

While the present invention has been described in accordance with preferred compositions and embodiments, it is to be understood that certain substitutions and alterations may be made thereto without departing from the spirit and scope of the following claims.

1. A method for using the Internet to facilitate a transaction between a customer and at least one supplier of music scores to discourage illegal copying of music scores, comprising:
associating suppliers (26, 28, 30) of music scores with a music score service unit (18);
a customer (12) contacting a website (16) of the service unit (18) and sending a request signal (19) to the website (16) to obtain a music score (20);
the service unit (18) receiving the signal (19) and the service unit (18) digitally searching for the music score (20) in a database (22) to determine whether the music score (20) is available in the database (22);
when no copy of the music score (20) being available in the database (22), the unit (18) sending request signals (24a-c) to the suppliers (26, 28, 30);
the suppliers (26, 28, 30) sending back an affirmation signal (32) to the service unit (18) when a digital copy (35) of the music score (20) is available from the suppliers;
the service unit (18) receiving the affirmation signal (32); the service unit (18) sending a delivery request signal (41) to the supplier (28);
the supplier (28) sending the digital copy (35) of the music score (20) to the service unit (18); and
the service unit (18) receiving the digital copy (35) of the music score (20) and sending a delivery signal (36) to the customer including the digital copy (35) of the music score (20).

2. The method according to claim 1 wherein the method further comprises the service unit (18) sending the digital copy (35) to the customer (12) when the digital copy (35) is available in the database (22).

3. The method according to claim 1 wherein the method further comprises the customer (12) pre-paying for the digital copy (35).

4. The method according to claim 1 wherein the method further comprises the service unit (18) compensating the supplier (28) with the payment amount received from the customer (12) minus a service charge.

5. The method according to claim 1 wherein the method further comprises the service unit (18) charging the customer (12) a reduced fee or no fee at all when the digital copy (35) is not delivered within a promised time period.

6. The method according to claim 1 wherein the method further comprises the service unit (18) providing transposition services to the customer (12).

7. The method according to claim 1 wherein the method further comprises the supplier (28) sending a royalty payment to a copyright control function (33) associated with a copyright owner (34).

8. The method according to claim 1 wherein the method further comprises the service unit (18) sending a charge signal (37) to the customer (12) to request payment of the digital copy (35) and the customer (12) sending a payment signal (39) to the service unit (18).
